(19) United States
(12) Patent Application Publication
(10) Pub. No.: US 2020/0293997 A1
(43) Pub. Date: Sep. 17, 2020

(54) MAINTENANCE STAFF SCHEDULING METHOD BASED ON COMPOUND INTERNET OF THINGS (IOT) AND IOT SYSTEM

(71) Applicant: Chengdu Qinchuan Technology Development Co., Ltd., Chengdu (CN)

(72) Inventor: Zehua SHAO, Chengdu (CN)

(21) Appl. No.: 16/355,694

(22) Filed: Mar. 15, 2019

(51) Int. Cl. G06Q 10/10; H04L 29/08; G08B 21/18

(52) U.S. Cl. CPC G06Q 10/1093; G08B 21/18; H04L 67/12

(57) ABSTRACT

The present invention provides a maintenance staff scheduling method based on a compound Internet of Things (IoT) and an IoT system, and relates to the field of the maintenance staff scheduling method based on the compound IoT and the IoT system. According to the maintenance staff scheduling method based on the compound IoT and the IoT system provided by the present invention, a maintenance staff may be scheduled reasonably according to fault handling of a gas meter, and thus the fault handling efficiency of the intelligent gas meter is improved.

### TECHNICAL FIELD

The present invention relates to the field of the Internet of Things (IoT), and in particular to a maintenance staff scheduling method based on a compound IoT and an IoT system.

### BACKGROUND

Along with ever-changing development of an IoT technology, various instruments and meters, such as a gas meter, also enter the sector of an IoT. A traditional gas meter has been gradually replaced by an IoT intelligent gas meter.

In the process when a user uses the gas, the intelligent gas meter may occur various faults. In order to ensure that the intelligent gas meter can be used normally, it is a common practice to manually schedule a maintenance staff to handle a fault of the intelligent gas meter. However, a manual scheduling manner has a large defect, and it is common that a staff is scheduled and allocated unreasonably so that the fault handling efficiency is low and thus the user experience during use is poor.

Therefore, how to schedule the maintenance staff reasonably and improve the fault handling efficiency of the intelligent gas meter is a difficult problem to be solved urgently in the prior art.

### SUMMARY OF THE INVENTION

In view of this, an objective of the present invention is to provide a maintenance staff scheduling method based on a compound IoT and an IoT system to schedule a maintenance staff reasonably and improve the fault handling efficiency of an intelligent gas meter.

To this end, the technical solutions adopted by the present invention are as follows:

According to a first aspect, the present invention provides a maintenance staff scheduling method based on a compound IoT; the method is applied to an IoT system; the IoT system includes a plurality of object sub-platforms, a plurality of sensor network sub-platforms, a plurality of management sub-platforms, a plurality of service sub-platforms and a user platform; each of the object sub-platforms includes a gas meter; each of the sensor network sub-platforms includes an IoT intelligent gateway; each of the management sub-platforms includes a management server of a gas company; and the method includes:

sending, by each faulty gas meter, fault information to a corresponding management sub-platform via a corresponding sensor network sub-platform, where the fault information includes identification information of the corresponding gas meter, fault occurrence time, a fault type and an area where a fault is located;

generating, by each management sub-platform, a scheduling strategy according to all received fault information and the number of pre-configured maintenance staff, and sending the generated scheduling strategy to at least one of the plurality of service sub-platforms; and

sending, by a service sub-platform that receives the scheduling strategy, the scheduling strategy to the user platform.

Further, each management platform is provided with a scheduling model in advance; and the step of generating, by each management sub-platform, a scheduling strategy according to all received fault information and the number of pre-configured maintenance staff includes:

quantizing, by each management sub-platform, all received fault information and then taking the quantized fault information and the number of pre-configured maintenance staff as an input of a scheduling model thereof for operation to obtain the scheduling strategy, wherein

the scheduling strategy includes a plurality of scheduling events, and each of the scheduling events includes identification information of a faulty gas meter, fault handling time, and a name of a maintenance staff.

Further, each of the scheduling models is established based on a principle that the average fault handling time is the shortest or a principle that the total fault retention time is the shortest.

Further, the method includes:

sending, by the user platform, a scheduling model modification instruction corresponding to one of the management sub-platforms to at least one of the plurality of service sub-platforms; and

sending, by a service sub-platform that receives the scheduling model modification instruction, the scheduling model modification instruction to the corresponding management sub-platform, so that the management sub-platform modifies a scheduling model thereof.

Further, when the average number of scheduling events corresponding to each maintenance staff in one of the scheduling strategies is smaller than a set threshold, a management sub-platform corresponding to the scheduling strategy reduces the number of pre-configured maintenance staff and regenerates a scheduling strategy.

According to a second aspect, the present invention provides an IoT system; the IoT system includes a plurality of object sub-platforms, a plurality of sensor network sub-platforms, a plurality of management sub-platforms, a plurality of service sub-platforms and a user platform;

each faulty gas meter sends fault information to a corresponding management sub-platform via a corresponding sensor network sub-platform, where the fault information includes identification information of the corresponding gas meter, fault occurrence time, a fault type and an area where a fault is located;

each management sub-platform generates a scheduling strategy according to all received fault information and the number of pre-configured maintenance staff, and sends the generated scheduling strategy to at least one of the plurality of service sub-platforms; and

a service sub-platform that receives the scheduling strategy sends the scheduling strategy to the user platform.

Further, each management sub-platform is provided with a scheduling model in advance; and the step that each management sub-platform generates a scheduling strategy according to all received fault information and the number of pre-configured maintenance staff includes:

quantizing, by each management sub-platform, all received fault information and then taking the quantized fault information and the number of pre-configured maintenance staff as an input of a scheduling model thereof for operation to obtain the scheduling strategy, wherein

the scheduling strategy includes a plurality of scheduling events, and each of the scheduling events includes identification information of a faulty gas meter, fault handling time, and a name of a maintenance staff.

Further, each of the scheduling models is established based on a principle that the average fault handling time is the shortest or a principle that the total fault retention time is the shortest.

Further, the user platform sends a scheduling model modification instruction corresponding to one of the management sub-platforms to at least one of the plurality of service sub-platforms; and

a service sub-platform that receives the scheduling model modification instruction sends the scheduling model modification instruction to the corresponding management sub-platform, so that the management sub-platform modifies a scheduling model thereof.

Further, when the average number of scheduling events corresponding to each maintenance staff in one of the scheduling strategies is smaller than a set threshold, a management sub-platform corresponding to the scheduling strategy reduces the number of pre-configured maintenance staff and regenerates a scheduling strategy.

For the prior art, the maintenance staff scheduling method based on the compound IoT and the IoT system provided by the present invention have the following beneficial effects:

The present invention provides a maintenance staff scheduling method based on a compound IoT and an IoT system. The method includes: sending, by each faulty gas meter, fault information to a corresponding management sub-platform via a corresponding sensor network sub-platform, where the fault information includes identification information of the corresponding gas meter, fault occurrence time, a fault type and an area where a fault is located; generating, by each management sub-platform, a scheduling strategy according to all received fault information and the number of pre-configured maintenance staff, and sending the generated scheduling strategy to at least one of the plurality of service sub-platforms; and sending, by a service sub-platform that receives the scheduling strategy, the scheduling strategy to the user platform. According to the maintenance staff scheduling method based on the compound IoT and the IoT system provided by the present invention, in a process of handling a fault of an intelligent gas meter, a maintenance staff can be scheduled reasonably, and thus the fault handling efficiency of the intelligent gas mater is improved.

To make the above objectives, characteristics and advantages of the present invention more apparent and understandable, preferred embodiments are set forth hereinafter and are described below in detail in combination with accompanying drawings.

### BRIEF DESCRIPTION OF DRAWINGS

To make the objectives, technical solutions and advantages of the embodiments of the present invention clearer, a clear and complete description of the technical solutions in the present invention will be given below in combination with the accompanying drawings in the embodiments of the present invention. Apparently, the embodiments described below are a part, but not all, of the embodiments of the present invention. Generally, a component, described and illustrated in the accompanying drawings, in the embodiments of the present invention may be disposed and designed in various different configurations. Therefore, the following detailed description concerning the embodiments of the present invention and provided in the accompanying drawings is not intended to limit a claimed scope of the present invention, but merely represents selected embodiments of the present invention. All of the other embodiments, obtained by a person of ordinary skill in the art based on the embodiments of the present invention without any inventive efforts, fall into the protection scope of the present invention.

FIG. 1 illustrates a compositional schematic diagram of an IoT system provided by an embodiment of the present invention;

FIG. 2 illustrates a flowchart of a maintenance staff scheduling method based on a compound IoT provided by an embodiment of the present invention;

FIG. 3 illustrates a display effect diagram of a scheduling strategy generated by a management sub-platform provided by an embodiment of the present invention; and

FIG. 4 illustrates a flowchart of another maintenance staff scheduling method based on a compound IoT provided by an embodiment of the present invention.

Numerals in the drawings: 100-IoT system; 10-object sub-platform; 20-sensor network sub-platform; 30-management sub-platform; 40-service platform; 50-user platform.

### DESCRIPTION OF EMBODIMENTS

A clear and complete description of the technical solutions in the present invention will be given below in combination with the accompanying drawings in the embodiments of the present invention. Apparently, the embodiments described below are a part, but not all, of the embodiments of the present invention. Generally, a component, described and illustrated in the accompanying drawings, in the embodiments of the present invention may be disposed and designed in various different configurations. Therefore, the following detailed description concerning the embodiments of the present invention and provided in the accompanying drawings is not intended to limit a claimed scope of the present invention, but merely represents selected embodiments of the present invention. All of the other embodiments, obtained by those skilled in the art based on the embodiments of the present invention without any inventive efforts, fall into the protection scope of the present invention.

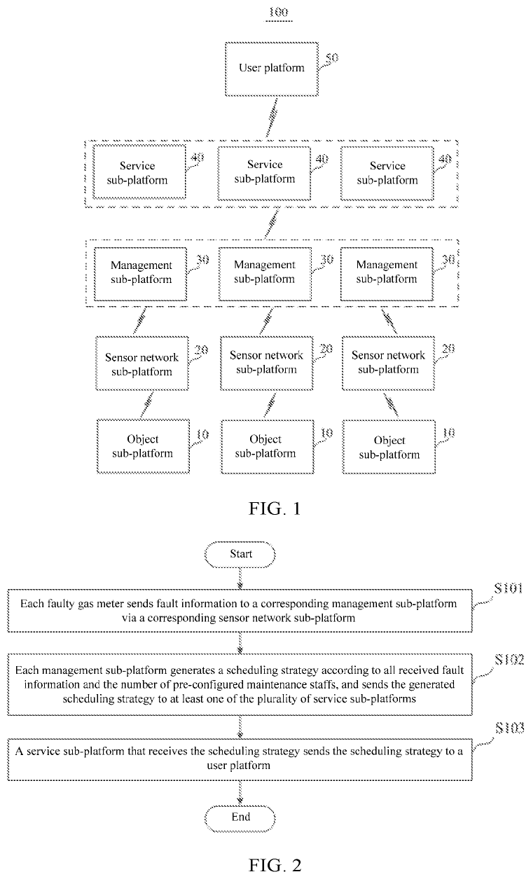

Referring to FIG. 1, a maintenance staff scheduling method based on a compound IoT provided by an embodiment of the present invention is applied to an IoT system 100. The IoT system 100 includes a plurality of object sub-platforms 10, a plurality of sensor network sub-platforms 20, a plurality of management sub-platforms 30, a plurality of service sub-platforms 40 and a user platform 50. Herein, the plurality of object sub-platforms 10 are respectively and communicatively connected with the plurality of management sub-platforms 30 via the plurality of sensor network sub-platforms 20, so as to respectively send relevant data of corresponding object sub-platforms 10 to the plurality of management sub-platforms 30, or receive control signals sent by corresponding management sub-platforms 30. The plurality of management sub-platforms 30 are respectively and communicatively connected with the plurality of service sub-platforms 40 and may push information to the plurality of service sub-platforms 40. Each of the object platforms 10 includes a gas meter. Each of the sensor network sub-platforms 20 includes an IoT intelligent gateway. The management sub-platforms 30 respectively include a management server of a gas company. The service sub-platforms 40 include an operation server, a portal website server or a government website server of the gas company. The user platform 50 includes a terminal device of an administrator of the gas company. According to the maintenance staff scheduling method based on the compound IoT and the IoT system provided by the present invention, in a process of handling a fault of an intelligent gas meter, a maintenance staff can be scheduled reasonably and thus the fault handling efficiency of the intelligent gas mater is improved.

See FIG. 2, which illustrates a flowchart of a maintenance staff scheduling method based on a compound IoT provided by an embodiment of the present invention. The process shown in FIG. 2 is described below in detail.

Step S101, each faulty gas meter sends fault information to a corresponding management sub-platform 30 via a corresponding sensor network sub-platform 20.

In this embodiment of the present invention, the management sub-platforms 30 each are a management server of a subsidiary of a gas company, each management sub-platform 30 may be used for managing all gas meters of a corresponding subsidiary, and one management sub-platform 30 may be communicatively connected with all gas meters of a subsidiary via one or more sensor network sub-platforms 20.

For easy understanding, in this embodiment of the present invention, one management sub-platform 30 is communicatively connected with all gas meters (object sub-platforms 20) of a corresponding subsidiary via one sensor network sub-platform 20.

When the IoT system is used, in a case where gas meters are faulty, each faulty gas meter sends fault information to a corresponding management sub-platform 30 via a corresponding sensor network sub-platform 20. The fault information includes identification information of the gas meter, fault occurrence time, a fault type, an area where a fault is located, etc. The identification information of the gas meter is used for identifying the faulty gas meter for maintenance.

In this embodiment of the present invention, the fault information includes the identification information of the gas meter, the fault occurrence time, the fault type and the area where the fault is located. Certainly, in other embodiments, the fault information may not include the area where the fault is located. Specifically, an area where each gas meter is located may be pre-recorded in the management sub-platforms 30, and after a management sub-platform 30 obtains identification information of a faulty gas meter, the management sub-platform 30 may know the area where the faulty gas meter is located according to the identification information.

Step S102, each management sub-platform 30 generates a scheduling strategy according to all received fault information and the number of pre-configured maintenance staff, and sends the generated scheduling strategy to at least one of the plurality of service sub-platforms.

A plurality of maintenance staff are provided for gas meters managed by each management sub-platform 30 so as to facilitate the maintenance of a faulty gas meter. Meanwhile, each management sub-platform 30 is provided with a scheduling model in advance for generating a scheduling strategy.

Upon the reception of fault information of a managed gas meter, each management sub-platform 30 quantizes all received fault information and then takes the quantized fault information and the number of pre-configured maintenance staff as an input of a scheduling model thereof for operation to obtain the scheduling strategy. In this embodiment of the present invention, each of the scheduling models may be established based on, but is not limited to, a principle that the average fault handling time is the shortest or a principle that the total fault retention time is the shortest. For example, when a scheduling model is established based on the principle that the total fault retention time is the shortest, and when maintenance staffs are allocated according to the generated scheduling strategy to maintain the faulty gas meters, the sum of fault retention time for all faulty gas meters is the shortest theoretically.

Each of the scheduling strategies includes a plurality of scheduling events, and each of the scheduling events includes identification information of a faulty gas meter, fault handling time, a name of a maintenance staff and the like, and may further include a fault type, etc. As shown in FIG. 3, if a management sub-platform 30 is provided with three maintenance staff and eight managed gas meters are faulty, the generated scheduling strategy includes eight scheduling events in total and each of the scheduling events includes identification information of a faulty gas meter (a serial number of the gas meter in FIG. 3), fault handling time, a fault type, a name of a maintenance staff, etc.

After each management sub-platform 30 generates the scheduling strategy, the generated scheduling strategy is sent to at least one of the plurality of service sub-platforms 40.

Step S103, a service sub-platform 40 that receives the scheduling strategy sends the scheduling strategy to the user platform 50.

After the management sub-platform 30 sends the generated scheduling strategy to the at least one of the plurality of service sub-platforms 40, the service sub-platform 40 that receives the scheduling strategy sends the scheduling strategy to the user platform 50.

The user platform 50 is a terminal device of an administrator of the gas company, and in this way, the administrator of the gas company at the user platform 50 may uniformly schedule, according to the received scheduling strategy, a maintenance staff provided for each management sub-platform 30. Therefore, the maintenance staff is scheduled reasonably and thus the fault handling efficiency of the intelligent gas meter is improved.

Further, in this embodiment of the present invention, the scheduling model of each management sub-platform 30 may be modified by the user platform 50. Specifically, when the administrator of the gas company at the user platform 50 needs to modify a scheduling model of a management sub-platform 30, a scheduling model modification instruction corresponding to the to-be-modified management sub-platform 30 may be sent to one or more of the plurality of service sub-platforms 40 via the user platform 50. A service sub-platform 40 that receives the scheduling model modification instruction forwards the scheduling model modification instruction to the to-be-modified management sub-platform 30. Upon the reception of the scheduling model modification instruction, the to-be-modified management sub-platform 30 modifies the scheduling model according to the scheduling model modification instruction.

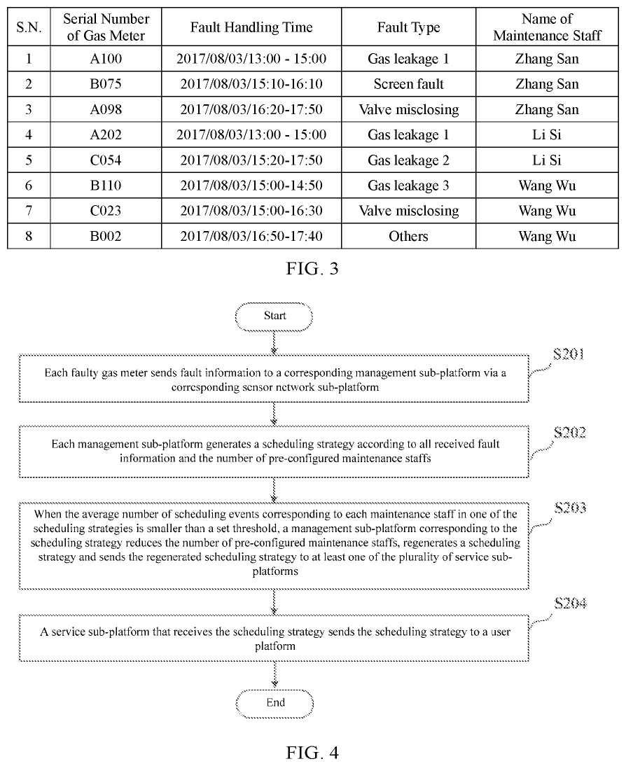

See FIG. 4, which illustrates a flowchart of another maintenance staff scheduling method based on a compound IoT provided by an embodiment of the present invention. The process shown in FIG. 4 is described below in detail.

Step S201, each faulty gas meter sends fault information to a corresponding management sub-platform 30 via a corresponding sensor network sub-platform 20.

Step S202, each management sub-platform 30 generates a scheduling strategy according to all received fault information and the number of pre-configured maintenance staff.

Step S203, when the average number of scheduling events corresponding to each maintenance staff in one of the scheduling strategies is smaller than a set threshold, a management sub-platform 30 corresponding to the scheduling strategy reduces the number of pre-configured maintenance staff, regenerates a scheduling strategy and sends the regenerated scheduling strategy to at least one of the plurality of service sub-platforms 40.

In this embodiment of the present invention, each management sub-platform 30 is provided with a threshold in advance for determining whether the number of per capita scheduling events is too small or not. If the number of per capita scheduling events (i.e., the average number of scheduling events corresponding to each maintenance staff) is smaller than the threshold, it is indicated that the average number of scheduling events allocated to each person at present is too small and such an allocation manner will cause the waste of human resources.

Therefore, in the maintenance staff scheduling method based on the compound IoT provided by this embodiment of the present invention, when the average number of scheduling events corresponding to each maintenance staff in one of the scheduling strategies is smaller than the set threshold, a management sub-platform 30 corresponding to the scheduling strategy reduces the number of configured maintenance staff, regenerates a scheduling strategy and sends the regenerated scheduling strategy to at least one of the plurality of service sub-platforms 40.

In this way, when the average number of scheduling events allocated to each person at present is too small, the configured number of maintenance staff for handling faults of gas meters may be reduced, and thus the maintenance staff is scheduled reasonably and the waste of the human resources is prevented.

Step S204, a service sub-platform that receives the scheduling strategy sends the scheduling strategy to the user platform.

In conclusion, according to the maintenance staff scheduling method based on the compound IoT and the IoT system provided by the embodiments of the present invention, each faulty gas meter sends fault information to a corresponding management sub-platform 30; then, each management sub-platform 30 generates a scheduling strategy according to all received fault information and the number of pre-configured maintenance staff and sends the scheduling strategy to a service sub-platform 40, and at last the service sub-platform 40 sends the scheduling strategy to a user platform 50. In this way, the administrator of the gas company at the user platform 50 may uniformly schedule, according to the received scheduling strategy, a maintenance staff provided for each management sub-platform 30. Therefore, the maintenance staff is scheduled reasonably and thus the fault handling efficiency of the intelligent gas meter is improved. Meanwhile, according to the maintenance staff scheduling method based on the compound IoT and the IoT system provided by the embodiments of the present invention, a scheduling model of a management sub-platform 30 may further be modified as required. In addition, according to the maintenance staff scheduling method based on the compound IoT and the IoT system provided by the embodiments of the present invention, when the average number of scheduling events allocated to each maintenance staff at present is too small, the number of maintenance staffs for handling faults of gas meters may be reduced, and thus the maintenance staff is scheduled reasonably and the waste of the human resources is prevented.

In several embodiments provided by the present application, it should be understood that the disclosed apparatus and method may also be implemented in other manners. The described apparatus embodiments are merely exemplary. For example, the flowcharts and block diagrams in the drawings illustrate the system architecture, function, and operation of possible implementations of apparatuses, methods, and computer program products according to various embodiments of the present invention. In this regard, each block in the flowcharts or block diagrams may represent a module, program segment, or portion of code, which includes one or more executable instructions for implementing the specified logical function(s). It should also be noted that in some alternative implementation manners, the functions noted in the block may occur out of the sequence noted in the drawings. For example, two continuous blocks, in fact, may be executed concurrently, or in a reverse order, which will depend upon the functions involved. It will also be noted that each block of the block diagrams and/or flowcharts, and combinations of blocks in the block diagrams and/or flowcharts, may be implemented by a special hardware-based IoT system that performs the specified functions or acts, or by using combinations of special hardware and computer instructions.

In addition, each module in the embodiments of the present invention may exist independently, and two or more modules may be integrated into an independent part.

When a function is implemented in the form of the software functional unit and sold or used as a separate product, the function may be stored in a computer readable storage medium. Based on such understanding, the technical solutions of the present invention or the part that makes contributions to the prior art or a part of the technical solutions may be substantially embodied in a form of a software product. The computer software product is stored in a storage medium, and includes several instructions to instruct a computer device (which may be a personal computer, server, network device, or the like) to execute all or some steps of the methods described in the embodiments of the present invention. The foregoing storage medium includes: various media capable of storing a program code, such as a disk, a mobile hard disk, a Read-Only Memory (ROM), a Random Access Memory (RAM), a magnetic disk or an optical disk. It should also be noted that, in the description, such relation terms as first and second are merely used for distinguishing one entity or operation from the other entity or operation, rather than requiring or hinting that these entities or operations have any practical relation or sequence. Moreover, the terms “comprise”, “include” or any other variant are intended to cover non-exclusive inclusion, so that the processes, methods, articles or devices including a series of factors not only include those factors, but also include other factors listed implicitly, or further include inherent factors of the processes, methods, articles or devices. In the absence of more limitations, the factors defined by the statement “include one . . . ” do not exclude other identical factors in the processes, methods, articles or devices including said factors.

The above are merely preferred embodiments of the present invention, and are not intended to limit the present invention. A person skilled in the art may make various modifications and changes to the present invention. Any modification, equivalent replacement, improvement and the like made within the spirit and principle of the present invention all shall be included in a scope of protection of the present invention. It should be noted that similar reference numerals and letters refer to similar items in the following drawings, and thus once an item is defined in one drawing, it does not need to be further defined and explained in the subsequent drawings.

The foregoing descriptions are merely specific implementation manners of the present invention, but are not intended to limit a scope of protection of the present invention. Any variation or replacement readily figured out by a person skilled in the art within the technical scope disclosed in the present invention shall fall within the scope of protection of the present invention. Therefore, the scope of protection of the present invention shall be subject to the scope of protection of the claims.

It should also be noted that, in the description, such relation terms as first and second are merely used for distinguishing one entity or operation from the other entity or operation, rather than requiring or hinting that these entities or operations have any practical relation or sequence. Moreover, the terms “comprise”, “include” or any other variant are intended to cover non-exclusive inclusion, so that the processes, methods, articles or devices including a series of factors not only include those factors, but also include other factors listed implicitly, or further include inherent factors of the processes, methods, articles or devices. In the absence of more limitations, the factors defined by the statement “include one . . . ” do not exclude other identical factors in the processes, methods, articles or devices including said factors.

What is claimed is:

1. A maintenance staff scheduling method based on a compound Internet of Things (IoT), wherein the method is applied to an IoT system; the IoT system comprises a plurality of object sub-platforms, a plurality of sensor network sub-platforms, a plurality of management sub-platforms, a plurality of service sub-platforms and a user platform; each of the object sub-platforms comprises a gas meter; each of the sensor network sub-platforms comprises an IoT intelligent gateway; each of the management sub-platforms comprises a management server of a gas company; and the method comprises:
sending, by each faulty gas meter, fault information to a corresponding management sub-platform via a corresponding sensor network sub-platform, wherein the fault information comprises identification information of the corresponding gas meter, fault occurrence time, a fault type and an area where a fault is located;
generating, by each management sub-platform, a scheduling strategy according to all received fault information and the number of pre-configured maintenance staff, and sending the generated scheduling strategy to at least one of the plurality of service sub-platforms; and
sending, by a service sub-platform that receives the scheduling strategy, the scheduling strategy to the user platform.

2. The maintenance staff scheduling method based on the compound IoT according to claim 1, wherein each management platform is provided with a scheduling model in advance;
and the step of generating, by each management sub-platform, a scheduling strategy according to all received fault information and the number of pre-configured maintenance staff comprises:
quantizing, by each management sub-platform, all received fault information and then taking the quantized fault information and the number of pre-configured maintenance staff as an input of a scheduling model thereof for operation to obtain the scheduling strategy, wherein
the scheduling strategy comprises a plurality of scheduling events, and each of the scheduling events comprises identification information of a faulty gas meter, fault handling time, and a name of a maintenance staff.

3. The maintenance staff scheduling method based on the compound IoT according to claim 2, wherein each of the scheduling models is established based on a principle that the average fault handling time is the shortest or a principle that the total fault retention time is the shortest.

4. The maintenance staff scheduling method based on the compound IoT according to claim 2, wherein the method further comprises:
sending, by the user platform, a scheduling model modification instruction corresponding to one of the management sub-platforms to at least one of the plurality of service sub-platforms; and
sending, by a service sub-platform that receives the scheduling model modification instruction, the scheduling model modification instruction to the corresponding management sub-platform, so that the management sub-platform modifies a scheduling model thereof.

5. The maintenance staff scheduling method based on the compound IoT according to claim 1, wherein when the average number of scheduling events corresponding to each maintenance staff in one of the scheduling strategies is smaller than a set threshold, the management sub-platform corresponding to the scheduling strategy reduces the number of pre-configured maintenance staff and regenerates a scheduling strategy.

6. An Internet of Things (IoT) system, comprising a plurality of object sub-platforms, a plurality of sensor network sub-platforms, a plurality of management sub-platforms, a plurality of service sub-platforms and a user platform, wherein
each faulty gas meter sends fault information to a corresponding management sub-platform via a corresponding sensor network sub-platform, wherein the fault information comprises identification information of the corresponding gas meter, fault occurrence time, a fault type and an area where a fault is located;
each management sub-platform generates a scheduling strategy according to all received fault information and the number of pre-configured maintenance staff, and sends the generated scheduling strategy to at least one of the plurality of service sub-platforms; and
a service sub-platform that receives the scheduling strategy sends the scheduling strategy to the user platform.

7. The IoT system according to claim 6, wherein each management platform is provided with a scheduling model in advance; and the step that each management sub-platform generates a scheduling strategy according to all received fault information and the number of pre-configured maintenance staff comprises:
quantizing, by each management sub-platform, all received fault information and then taking the quantized fault information and the number of pre-configured maintenance staff as an input of a scheduling model thereof for operation to obtain the scheduling strategy, wherein
the scheduling strategy comprises a plurality of scheduling events, and each of the scheduling events comprises identification information of a faulty gas meter, fault handling time, and a name of a maintenance staff.

8. The IoT system according to claim 7, wherein each of the scheduling models is established based on a principle that the average fault handling time is the shortest or a principle that the total fault retention time is the shortest.

9. The IoT system according to claim 7, wherein the user platform sends a scheduling model modification instruction corresponding to one of the management sub-platforms to at least one of the plurality of service sub-platforms; and
a service sub-platform that receives the scheduling model modification instruction sends the scheduling model modification instruction to the corresponding management sub-platform, so that the management sub-platform modifies a scheduling model thereof.

10. The IoT system according to claim 6, wherein when the average number of scheduling events corresponding to each maintenance staff in one of the scheduling strategies is smaller than a set threshold, a management sub-platform corresponding to the scheduling strategy reduces the number of pre-configured maintenance staff and regenerates a scheduling strategy.
